(19) United States
(12) Patent Application Publication
(10) Pub. No.: US 2016/0155130 A1
(43) Pub. Date: Jun. 2, 2016

(54) GLOBAL SYSTEM FOR THE ADMINISTRATION OF CARBON BALANCING

(71) Applicant: Ertugrul KALE, Balmumcu Besiktas, Istanbul (TR)

(72) Inventor: Ertugrul KALE, Istanbul (TR)

(21) Appl. No.: 14/906,431

(22) PCT Filed: Jul. 16, 2014
(86) PCT No.: PCT/TR2014/000275

§ 371 Date: Jan. 20, 2016

(30) Foreign Application Priority Data
Jul. 22, 2013 (TR) 2013/08872

(51) Int. Cl. G06Q 30/00

(52) U.S. Cl. CPC G06Q 30/018

(57) ABSTRACT

A program provides for the saving a certain percent of the sum paid by people for their consumed products or saving of the units detected by the international carbon footprint calculation methods for CARBON BALANCE by the manufacturers and/or consumers for maintaining a clean and sustainable environment in the whole world; and establish and spread Global Carbon Balance (GCB) system by determining, recording, processing the release and zeroing data of this system and transferring to green projects.

### TECHNICAL FIELD

The method according to the invention relates to method for supplying companies with readymade infrastructure for Global Carbon Balancing.

### BACKGROUND ART

Greenhouse gas emission takes places at all stages of production and consumption. These emission levels can be scientifically measured, and measuring said emission amounts is made subject to international standards by United Nations. Environmental institutions like DEFRA, IPCC, EPA publish this measuring system; carbon footprint calculation, and carbon footprint absorption calculation directly, and make available for cooperate and personal use.

Object of this calculation is, in addition to measuring, tracking, making provision of the greenhouse gases emergent during continuous economical activities of persons and companies, to become self-aware about this subject, to direct persons or companies to reduce greenhouse gases they reveal, or to positive activities to balance it. This activity is called as Carbon Balance.

Observing carbon balancing activities in an extensive way, it can be said that there are either corporate or personal solutions to be proposed and these are individual. Checking over corporations, it can be said that the measurements carried out by them for the greenhouse gases they produce during their product or service manufacturing, and projects based on these measurements generally cover corresponding corporation and targets the greenhouse gases produced during the manufacturing in production facilities. Inspecting the consumption stage and persons, it can be said that the carbon release depends upon the personal effort and awareness level. Communication studies in this respect are performed in terms of increasing awareness and raising awareness stage or within the framework of limited green projects.

There exists no system, which constitutes a connection and provides their communication, between corporations and end users who utilize the products manufactured by said corporations. On the other hand; there has been no system proposed that both provides this communication, and continuity of persons' effort, and its record and consistency. A green project providing a system that is interactive, taking international measuring standards as standard, and providing measurable results, when Social Responsibility projects and communication is the question has not been proposed.

Consequently, it has been made necessary to make a development in the technical field due to the abovementioned disadvantages and incapability of current solutions in terms of this subject.

### THE OBJECT OF THE INVENTION

The invention is created being inspired from the present case, and aims to solve the abovementioned disadvantages.

The “Method For Supplying Companies With Readymade Infrastructure For Global Carbon Balancing System” according to the invention is an “Integrated Communication Program” including projects for protection the nature comprising Customer Loyalty

Card application. Our idea developed within said “Integrated Communication Program” aims to gather all consumers under GCB, and execute environment friendly activities with funds to be reserved in a certain amount during purchasing/selling of products that harm the environment due to carbon release, thereby raising awareness of consumers and developing the environment by protecting it.

Aim herein is to detect, calculate, record, collect the equivalent TL value of the carbon release of said product during sale of products or services of a company with the Customer Loyalty Card system; and to collect said equivalent TL amount, to transfer said funds arising as a result of said collection to corresponding Social Responsibility Projects that is relating to and will be executed regarding environmental issues. In other words, all the Pool-of-Funds equivalent to the detected cumulative emission releases during the retail sales belonging to all companies and end users in said Program will be transferred to responsibility projects for environment, and communication projects will be carried out on this topic.

The underlying idea of the program is to provide saving a certain percent of the sum paid by persons for their consumed products or saving of the units detected by the international carbon footprint calculation methods for CARBON BALANCE by the manufacturers and/or consumers for maintaining a clean and sustainable environment in the whole world, and to establish and extend Global Carbon Balance (GCB) by transferring the funds to be established with these units to environmental projects.

The program serves for bringing companies and consumers together under GCB system and provides information flow and communication, which has not been done or thought before.

Checking the companies and persons within the scope of environmentalist approaches
1. There are measuring, monitoring, reporting and promotion (PR) activities run individually by companies. Our object is to gather companies under same roof, and provide establishment of a common fund verified by financial and legal inspection, and execution of environmentalist activities by way of this fund to be founded by carbon release and balance. To sum up, the fund to be established will make it possible to cover necessary expenses for Global Carbon Balance.
2. The method according to the invention makes it possible to automatically detect, record, monitor of the greenhouse gases produced during manufacturing and consuming, and establish fund pool formed of carbon release units recorded during shopping by integrating Customer Loyalty Card system at first stage, and use of Payment Cards at shopping points at next stage.
3. Thanks to the record taken during shopping, it enables to determine the carbon release not only during manufacturing, but also during consumption.
4. Monitoring of carbon release units that are recorded, detected and stored in database with Card Systems over the web platform provides consumers with information about their own carbon footprints, and causes a raise in awareness, and making informed choices.
5. By the use of card systems technology (hardware and software), carbon footprint is automatically calculated. By this means, calculations that cannot be done individually are done automatically, and this information is provided to persons registered in corresponding web page.
6. Funds in this interactive system where companies and persons join with environmental consciousness are transferred to green, environmentalist projects that will absorb created carbon footprint; a common carbon balance process is performed.
7. Prestige of companies is protected and increased as a result of public relations and communication studies based on green projects to be recommended by nongovernmental organizations or as Social Responsibility Projects of companies. Companies in economy that have not yet taken part in this subject are motivated this way.
8. In carbon footprint field, a consistent, stable and systematic working field is created from this day on for companies that are to trade in compulsory carbon markets in future.
9. This system allows new companies to join this program, for making the program widespread and increasing environmental projects for absorbing carbon release.

Other objects of the method according to the invention are given below:
Beyond the carbon zeroing exchange of companies in carbon market, directing to protect environmental values of countries, in which they are present thanks to the awareness of consumers, with projects; dealing with problems taking urgent precautions, and directing to projects that will form swallow areas
Thanks to Card Systems, calculating and reporting of carbon release unit automatically at the end user phase of product and services . . . Cards will be provided by companies that attend this program. There are two method available:
Delivery of cards at these sales points, and inputting the registry into web-based system
Sending to user after registration is done on web-based client at sales point
Customer Relationship Management (CRM): It is a system that records ID, data about consumption patterns of end users, and analyzes them all. End user receives a card number when s/he gets loyalty card for the first time. This is also the CRM number within the Consumer Relations Management. This CRM number is card number, and “CRM code” of the user in the system.
To enable easily logging into the system for those having product and service to be sold to end users. Logging in the system by someone means registering to the system by filling the application form to the Program at sales point. Following the registration, end user gets CRM number.
To provide continuity and spreading of this initiative by offering a simple, easy, and user-friendly function in carbon release calculation and monitoring.
Thanks to web-portal and communication activities, end users and companies see and monitor carbon release units, and based thereon, make environment-friendly choices.
Since carbon release is reportable, visible; consciousness on the environment both personally and socially within this field is raised and extended.
Raising awareness of the society in carbon balance and direct them about consumption.
Ability of manufacturers, which are regarded as responsible for carbon release according to Kyoto Protocol, to collect accounting information thanks to this calculation, registering for the future, and gather accountable information.
Ability of companies to start carbon balance with the background for collecting funds over a ready and widespread network.
Existence of multiple companies on the same system at the same time, and creating synergy.
Compliance studies with the Ministry of Environment about Carbon Balance.

All the structural and characteristic features and all the advantages of the invention will be more clearly understood from the following FIGURE and detailed description for referring to these FIGURE and for this reason, it is necessary that the evaluation be done by taking these FIGURE and detailed description into account.

### FIGURES THAT SHALL ASSIST IN UNDERSTANDING THE INVENTION

FIG. 1 is a schematic view showing the elements in the method according to the invention, and the relations among these elements. (Unnumbered arrows are used for indicating the interaction of the elements, between which they are present.)

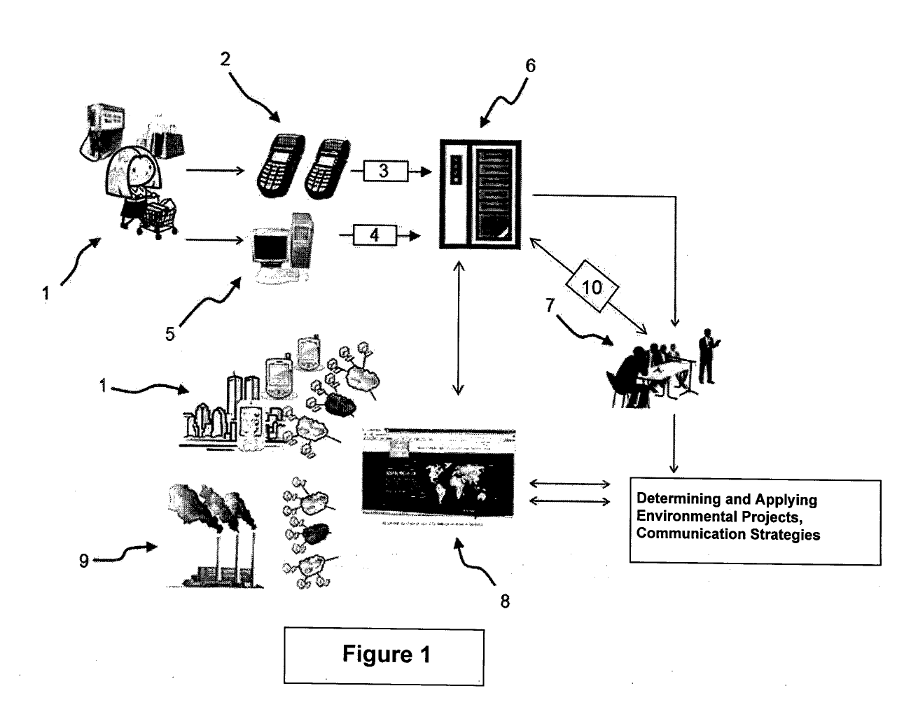

### DESCRIPTION OF PART REFERENCES

1. End user

2. Pos device

3. Phone network

4. Internet network

5. Computer

6. Main server

7. Marketing, Communication and Compliance group

8. Web platform

9. Company

10. Customer Relationship Management (CRM)

By all manner of means, the drawings must not be scaled necessarily and the details that are not necessary to figure out the present invention may have been ignored. Apart from this, the elements that are at least substantially identical and that have substantially identical functions are shown via same numbers.

### DETAILED DESCRIPTION OF THE INVENTION

Within this detailed description, preferred embodiments of the elements in the Method For Supplying Companies With Readymade Infrastructure For Global Carbon Balancing System according to the invention are disclosed for providing that the subject can be better understood.

The invention is the Method For Supplying Companies With Readymade Infrastructure For Global Carbon Balancing System in which name and contact information and/or information of the end user (1) to affect carbon release of the product s/he consumes are input to the web-based software of the web platform (8) as “credentials”; the information input to the Web software are processed to database via the web software on the main server (6); when purchasing is completed by the end user (1), the information (type and amount of the product) regarding the purchased consumer good is sent to the main server (6); thanks to the ID determination/authentication on the Database, the money-equivalent value corresponding to the automatically calculated carbon release according to end user's (1) “consumption subject” and “consumption amount” is recorded to said database; ability of the end user (2) and the company (9) selling said product that are registered to the web platform (8) to see the money-equivalent value corresponding to the carbon release and which projects are carried out with said money over the web platform (8).

Feature of the elements within the method according to the invention will be provided below respectively:

End user (1): The one purchasing product or service produced by the company has a

### Global Carbon Balancing System Card.

Company (9): Product or service producing foundation.

Carbon Release Calculation System: It is the method that provides calculation of the natural carbon release amount to the nature by producing or consuming each product according to DEFRA, EPA etc. international standards or a certain percentage to be determined.

Customer Loyalty Card System: A card system for providing the transfer of the TL-equivalent value information of the carbon release due to the consumer good and amount to be calculated with regard to international standards during shopping to the database where it is kept under record, and comprises of pos device, server, database, software, and chip or magnetic stripe plastic cards.

Software: The software that can analyzes data collected by Card System hardware, and make said data utilizable.

Customer Relationship Management (CRM) (10): The database that record the credentials of persons logging in the Loyalty card system, and system that analyzes, reports, renders the consumption patterns of said persons. When end user receives her/his card, the very own card number is CRM number. S/he is registered in the system with this number. Recording and monitoring is performed over this number. Web Platform (8): Centrally, it is the web page in which member companies, manufacturers, service providers and card owners, voluntary foundations, nongovernmental institutions are shared to the public, and that is used during the process of announcing objects, collected sums, spending and sales points, receiving and reporting creative ideas. Via this web page, social media management is to be carried out.

FUNDS Management: Inspection of the funds equivalent to total collected carbon release in System to be calculated in accordance with international standards, which is to be spend fit for the purpose, and funds management will be executed by offering projects suitable for this.

Marketing, Communication and Compliance Group (7): The group including the personnel who are to report information infrastructure and funds collected by the company in introducing products, and at points where there are companies to be engaged having end sales, and POS points with POS machine (2), and who are to carry out the compliance works that provide announcing on social media.

Project Research Group: Group that takes suggestions for carbon emission balancing work, and provides the encouragement for suggestion providers.

Ministry of Environment Cooperation Group: Group that provides spending collected funds under control of the Ministry of Environment and Urban Planning, Ministry of Forestry and Water Affairs, Ministry of Energy and related units, and propriety inspection.

As it is known, there are carbon based gases released to the environment both in manufacturing and use of a product. The mankind continues to harm the nature and ruin natural balance by, first of all, damaging Amazon forests with rich flora, which is the heart of the world, in the way ruining the balance of nature to convert it into oxygen in which it refreshes these gases thanks to plants with its own ecological chain, and due to trees cut resulting in the collected greenhouse and heating gases in poles.

In the past, companies dealt with carbon balance issue. Yet, they did not do these projects with consumers or end users.

Even if end users had wished to support Carbon Balance by purchasing product in a pool supporting each other just with a single card, it would have not been possible to make this real. The system according to the invention makes it possible to allocate funds for all purchases in a supermarket, petrol station, shopping center, shops; and collection of said funds by sharing it among the manufacturers.

The system according to the invention has been prepared, first of all, to plant trees, provide preferring less carbon releasing products with conscious consumption, execution of projects that aim to zero carbon gases, and become a bridge and organizer between manufacturers and consumers. Thanks to the system according to the invention, GLOBAL CARBON BALANCE will be supported.

Companies, end users and manufacturers need the infrastructure that is compliant with Ministry of Environment and Urban Planning, Ministry of Forestry and Water Affairs and related units, open to inspection and expansion, namely the system according to the invention.

Due to the abovementioned reasons, it has been compulsory to monitor manufacturers and consumers, value adding distribution companies and sales points by a central computer system.

Features of the elements active in the method according to the invention will be described below in details:

### Company (9):

Companies are any type of firms that produce products and services, and make retail trade. A company in any sector that is present in purchasing process of a consumer for product and service at sales points can be incorporated into the system according to the invention.

Within the Global Carbon Balancing System according to the invention; the work will first start from the companies that do production, distribution and sale of fuel produced by processing the petrol and natural gas raw materials for the machines that carry human and goods on air, on water and land, which execute transportation work especially on air, water and land. This “integrated communication system” can be used in any field including fast consumption service and goods, informatics technologies.

### End Users (1):

End users (1) will be able to monitor their shared funds and use areas with customer loyalty number and GCB card in expenses and purchases they make, and become sharers.

### Product's Carbon Release Calculation System:

Companies (9) connecting to the system will describe production process and input the data how much carbon gas they release for their unit products directly or indirectly during manufacturing process. Thanks to this, when a product is consumed, it is known with how much GCB unit the Carbon Balance (from tree planting and CO2 (carbon dioxide) to O2 (oxygen)) is required, and balance need will be monitored financially.

This calculation method will be done according to the international carbon footprint calculation based on the GHG Protocol accepted by the United Nations and ISO Standard 14064-I. Carbon release unit of any product will be converted into currency (TL, USD, EURO) according to the value determined by international organizations.

Every product and service has different calculation methods according to abovementioned international standards:
Products like fuels release different carbon gases depending upon internal combustion engines where they are used. For this reason, carbon release of fuel will be monitored according to the license plate, and displacement and efficiency of vehicle's engine information.
Internationally accepted practical calculation methods depending on the type of vehicles (personal car, caravan, couch, truck etc.) may be applied.
When fast moving consumer goods is the case, customers will be led to choose those with less carbon gas along with its price, for example pasta, checking the carbon release factor written from GBC-10 to GBC-5 among the trademarks on shelves.

By means of the carbon release calculation system, the m3 and amounts will be determined that are to be balanced. The system according to the invention will provide consultancy services to companies or inform about carbon release absorption methods.

### Customer Loyalty Cards System:

In determining, recording, monitoring and communicating the carbon release amount produced by companies and persons, Card Systems will be used.

Modules of the card system comprises of card including personal information of end users, POS device (2) and software in retail sales center, main server (6) and main software in this server. Accordingly, this system to be used in calculation and recording of TL amount equivalent to resultant carbon footprint is a card system consisting of pos device (2) that provides transfer of information during shopping to database that will be kept under record in main server (6), main server (6), database, software, and chip or magnetic stripe type plastic cards delivered to customers.

In addition to name and contact information of end users, when required by the goods (for example fuel: car model and year information for calculation carbon release); required hardware, machine information for the use of goods to be consumed will be entered to web-based computer software as “credentials” and these data will be processed to the database in the main server (6) via web software. The Plastic Card representing the credentials record in this database server will be delivered to the end user. Said plastic card may be chip or magnetic stripe type.

When the end user does her/his shopping from shopping point included in this program, the Card will be read by POS devices (2) or consumption information of the person will be entered to the computer. By means of POS devices (2) or Internet network (4), these credentials will be sent to the main server (6), and TL equivalent corresponding to the automatically calculated carbon release according to user's “consumption subject” and “consumption amount” with ID determination/authentication process in the database. This information will be shown in the web portal. This information will be seen by the employee at sales point or responsible persons in joining companies or vendors undertaking setup and running of Card System.

### Software:

The software that records personal information and consumption/carbon release information, namely CRM information; analyzes the data entered to the system from sales points and other points, and makes them utilizable.

### Web Platform (8):

Web platform (portal) (8) is a system that contains information of member companies (9), nongovernmental institutions and persons included in the Global Carbon Balancing System according to the invention; and provides interactive communications with companies and persons.

Firstly, companies (9) that are member of the web platform (portal) (8) and information about how much carbon gas that their products release during manufacturing, and information about carbon gas release during product use are kept in web platform (8). Card owner end users (1) and companies (9) attending the program can monitor the total belonging them by way of membership number by signing up this web page, and at the same time they will be able to see which environmental projects will be executed with this total amount.

Finally, funds established for environment are announced herein, and executed environmental projects with these funds are published on web page. Cumulative carbon release information, executed environmental projects and their effects information will be announced herein.

### Marketing, Communication and Compliance Group (8):

Infrastructure and communication work for leading up to giving a demonstration to companies (9) that wish to join the system, making carbon release calculations, entering data to web platform (8) of companies, ability to monitor production conventions and sale-distribution process in certain confidentiality are carried out.

### FUNDS Management:

Communication and management support for monitoring and suitably spending of the source, which is recorded, collected; namely the obtained source thanks to the card system, and is equivalent to TL amount corresponding to carbon footprint at selling moment.

In the system according to the invention, the owner of the system does not collect money for carbon footprint zeroing; her/his task is: to incorporate foundations to footprint classification project, and undertake that the total amount resulting from the data of purchase of any clothing, food, transportation, and durable consumer goods accepted by Turkish Authorities and defined by international standards or as international standards, to monitor this, to calculate the TL equivalent amount of end users (1) to carbon footprint, and to consider them with environmental projects.

Here, “paying the money” means: “TL value equivalent” to carbon footprint resulting from the consumption will be transferred to an environmental project. In web platform (portal/page) (8), green (carbon emission balancing) projects within the framework of the system according to the invention will be announced. And a person will be able to join projects with the “accumulation” amount for balancing her/his own carbon emission and choose one among projects.

Companies/foundations incorporated in the system will join in three ways:

### 1. Joining by Undertaking:

When a company joins the system according to the invention, it undertakes executing or supporting a project that will partially or completely balance the carbon footprint arising from the goods or service use of its customers, which are its own production.

### 2. Carbon Footprint Calculation:

They can join carbon footprint calculation by joining card system, and may not give an undertaking.

### 3. Joining Environmentalist Projects:

They can support projects without joining carbon footprint calculation.

### Project Research Group:

A system with GLOBAL perspective for FUNDS management that is environment friendly, developing project for carbon release balancing. Monitoring and reporting will be done through web portal (8).

Relations with Ministry of Environment:

These projects will be run in association with Ministry of Environment in order to provide communication with Ministry of Environment in Turkey and associated public and NGOs in other countries, establish a ground for companies, public awareness and documentation system in company, funds management issues.

The method according to the invention relates to method for supplying companies with readymade infrastructure for Global Carbon Balancing will be processed as follows.
1. In web platform (8), in other words in web page, for balancing the carbon gases to arise from manufacturing and consumption of products from a number companies (9), the Global Carbon Balance (GCB) will be announced over web page.
2. There will be CARDs (Near Edge, Read-write, Mifare 1 KB, magnetic and Mifare 13.56 MHZ coded) of member companies (9) in the system to be given to their customers.
   a. Said cards will have visual (EMBOSS) 16 Numerical GCB personal tracking numbers.
   b. In magnetic coding, this card tracking number will be coded in Track 2.
   c. Mifare Serial Number will be read and saved to database.
   d. The following will be added to the Mifare 1 KB read-write RAN memory.
      i. All the carbon footprint units collected by card owner so far.
      ii. Name Surname of card owner
      iii. Other information
      iv. They will be written by coding up to 1 KB.
   e. Following purchases, workplaces that are members in the system will load TL amount equivalent to carbon footprint using the card.
   f. The card will be private, has names thereon, and claimed by applying from POS point member workplace or over Internet.
3. Member workplace will load designated money, depending upon the purchase, as the TL amount equivalent to carbon footprint in GCB system to card holder, namely to the end user (1). Loading process will be done as follows: Customer's CRM number will be determined by getting the card read (or entering CRM number in Internet Shopping) during the purchasing. This information will be delivered to the database in the online or offline server thanks to the software. In database, verification of credentials of customer number and matching will be done in the system. All this data will be saved in the database and loading will be done.
4. GCB Card Holder will be able to see all GCB product purchases so for and carbon footprint total accordingly, by making use of card number by connecting the GCB system over INTERNET.
5. GCB card holder will also be able to see the total of expenses made by companies (9), where s/he shops, and works done and funds collected for Carbon Balance.
6. Total of the collected money from the sales of member workplaces will be listed in GCB system.

“The Global Carbon Balancing System” according to the invention uses card systems. Initially, it will utilize Customer Loyalty Card systems. In following stages of this program, it will be expanded to contain banks, credit and debit cards of banks. In next stage, a system that includes shopping over Internet will be integrated.

In addition to this, smartphone applications are also projected for use of information in web platform (8).

On the other hand; even though we have considered the system according to the invention for fuel and fast moving consumer goods, it can be spread to any point and sector.

1. Method for supplying companies with readymade infrastructure for global carbon balancing system, characterized in comprising the steps of
inputting name and contact information and/or information of an end user to affect carbon release of the product s/he consumes to the web-based software of the web platform as “credentials”;
processing the information input to the web software to database via the web software on the main server;
sending the information regarding the purchased consumer good to the main server when purchasing is completed by the end user;
recording the money-equivalent value corresponding to the automatically calculated carbon release according to end user's “consumption subject” and “consumption amount” to said database, thanks to the ID determination/authentication on the database; and
seeing the availability of the money-equivalent value recorded to said database, and corresponding to the carbon release and which projects are carried out with said money over the web platform.

2. Method according to claim 1, characterized in comprising the step of:
in the step of “sending the information regarding the purchased consumer good to the main server when said purchasing is completed by the end user”, sending said “credentials” to the main server;
by using the customer loyalty card in which name, contact information and CRM number of the end user are present.

3. Method according to claim 1, characterized in comprising the steps of:
in the step of “sending the information regarding the purchased consumer good to the main server when said purchasing is completed by the end user”, swiping said “credentials” to the main server;
swiping the bank card and credit card in which name, contact information and CRM number of the end user are present with POS device; and
sending it via the Internet network following said swiping process.

4. Method according to claim 1, characterized in comprising the steps of:
in the step of “sending the information regarding the purchased consumer good to the main server when said purchasing is completed by the end user”, entering said “credentials” to main server;
entering the bank card in which name, contact information and CRM number, or bank credit card information of the end user are present to virtual POS system; and
sending it via the Internet network following said inputting process.

5. Method according to claim 2, characterized in that said customer loyalty cards:
are Near Edge, Read-write, Mifare 1 KB, magnetic and Mifare 13.56 MHZ coded;
have visual (EMBOSS) 16 Numerical GCB personal tracking number;
in magnetic coding, tracking number is coded in Track 2;
carbon footprint units collected by the user so far are present in Mifare 1 B read-write R/W memory.
